(19) United States
(12) Patent Application Publication
(10) Pub. No.: US 2018/0262084 A1
(43) Pub. Date: Sep. 13, 2018

(54) Repulsive magnetic motor and generator

(71) Applicant: Larry Lindon McReynolds, Proctorville, OH (US)

(72) Inventor: Larry Lindon McReynolds, Proctorville, OH (US)

(21) Appl. No.: 15/732,879

(22) Filed: Jan. 10, 2018

Related U.S. Application Data
(60) Provisional application No. 62/498,965, filed on Jan. 12, 2017.

(51) Int. Cl. H02K 7/09; F16C 32/04

(52) U.S. Cl. CPC H02K 7/09; F16C 32/0423; F16C 32/0402; F16C 32/0404

(57) ABSTRACT

The result of the characteristics associated with the magnetic and electro-static waves being generated from all naturally occurring refined magnets enabled the design of the Repulsive Magnetic Motor and Generator. The Repulsive Magnetic Motor and Generator is designed to take advantage of the different fields of a natural magnet's repulsion and power generation. The simplified design allows the same repulsive magnetic arm rotation found in the Repulsive Magnetic Motor to drive the magnets rotating through magnetic pick-up wire coils creating AC power in the Generator. Through external circuit design the AC power generated is offered in an AC or DC format. The Repulsive Magnetic Motor and Generator is designed to operate as a test device and as a production device due to the flexibility of the design.

The use of repulsive magnetic and electro-static fields as the driving force in the powering of other designs could widened the options available with wind, solar, nuclear, aquatic, oil, coal, wood and even steam power. The theory has presented a new and different way to view older understood actions in science, enabling a better understanding of why the resultant is the way it is and allowing a wider view of actions one could explore.

### BACKGROUND OF THE INVENTION

Throughout history there has been a desire to have a machine that would run forever. Any machine made of matter will fall far short of that goal, so the best to be hoped for is a design of a machine that will function in a desired manner for some time. Magnetic and Electro-Static waves are the best avenue in design to reach that limited goal. The Repulsive Magnetic Motor and Generator is the result of a design based on the positive and negative magnetic and electro-static standing waves of natural magnets, the zero balanced wave energy point in the middle of all magnetic and electro-static waves connecting the positive and negative potentials together and the importance of the ninety degrees separation of exactly equal potentials of magnetic and electrostatic waves during the waves induction into a receiving wire coil. The operation of the Repulsive Magnetic Motor and Generator uses my current theory developed on magnetic and electro-static waves and how their generation is able to produce AC power. My knowledge, interest and understanding of magnetic and electro-static wave induction theory greatly increased due to a better understanding of the process involved. My past work covering over forty years utilized the currently accepted magnetic theory and was enough to meet the needs of a Senior Communications Electronic Technician working in the field. During my work with electronics questions on magnets and the magnetic and electro-static field went un-answered as to what are fields, power, current, voltage and how are they made. In searching for the answers to my questions I have come to a different understanding of magnetic and electro-static waves, the power they process and some of the potential it offers as a possible solution to some of our current power problems. This design follows in that path. During the provisional concept and construction period, DC electro-magnets were considered as a possible means to allow positive feedback processes to aid the natural magnetic repulsive fields helping to power the Repulsive Magnetic Motor. With the provisional submittal reflected this design testing was done but the results did not show that to be the case. Even wire wound natural magnets only showed a very small effect using generated DC voltage in an effort to improve the repulsive force. The testing did show the weight saved by removing the DC generating circuits from the Repulsive Magnetic Motor's rotational arms and using the weight savings to lighten the rotational arms while doubling the existing natural magnets used in the fixed tunable repulsive magnet assembly reaped the best repulsive magnet force gain. Due to the weight changes in the current design, the Repulsive Magnetic Motor Assembly was moved to the top and the Generator Assembly was moved to the bottom reversing the order found in the provisional drawings. All the original concepts were maintained from the provisional submittal and no changes were needed to the basic design of the Repulsive Magnetic Motor and Generator.

### SUMMARY OF THE INVENTION

The Repulsive Magnetic Motor and Generator is comprised of two main assemblies. The top assembly comprises the Repulsive Magnetic Motor and the bottom assembly comprises the Generator. The Repulsive Magnetic Motor assembly houses all the fixed and tunable natural magnets used In the device to generate a repulsive magnetic and electro-static field. These include the fixed tunable repulsive magnet assemblies; the fixed repulsive magnets aligned on the rotational support arm and the lift and align magnets surrounding the inner case wall stabilizing the arm. The Generator houses all the magnetic pick-up wire coils used in the device and the natural magnets needed to revolving between the magnetic pick-up wire coils to generate AC Power.

The operation of the repulsive magnetic motor relies on the repulsive magnetic orientation of fixed and movable permeant natural magnets. The natural permeant magnets are arranged to allow the repulsive forces existing between the fixed and the moveable natural permeant magnet's magnetic and electro-static fields to produce rotational work generating AC power. In this design the repulsive forces used by the Repulsive Magnetic Motor are developed between the four rings of the fixed tunable repulsive motor's natural magnets and the six rotational arm repulsive motor magnet assemblies, containing sets of natural permeant magnets in one assembly attached to each of the six main motor and generator rotational arms. The repulsive force developed between the four rings of fixed natural magnets and the six rotational arm repulsive motor natural magnet assemblies result in the development of the rotation of the six rotational arms, attached to the center rotating shaft. Rotating the six main motor and generator rotational arms allow the movement of the six main rotational generator magnet assemblies to move through the twelve fixed main generator pick-up magnetic wire coils producing AC power. The ability to rotate six arms using one center shaft aids in over-all balance, support and stabilization of the moving parts of the motor and generator assemblies. Attached to and below the six motor and generator rotational arms are the six rotational arm generator natural magnet assemblies. Attached to and below the six motor and generator rotational arms are the natural magnets used in the six rotational arm generator magnet assemblies to revolve through the two rings of six fixed main generator pick-up magnetic wire coils, with each coil having three separate windings. The twelve fixed main generator pick-up magnetic wire coils use dual primary/single secondary phasing transformers to connect electrical and electronic circuit components to generate AC and DC electrical power.

The Repulsive Magnetic Motor and Generator assemblies offer two basic designs, each being simple, reliable and compact. Being able to stack additional Repulsive Magnetic Motor and Generator units together allows the coupling of the center rotating shafts aiding in synchronizing operations of the output voltages and yields with an increase in electrical power output. Repulsive Magnetic Motor and Generators are fully scalable in size and configuration fitting many different power output requirements. Other variations of the Repulsive Magnetic Motor and Generator may include, but are not be limited to, the size of the device and components used for each magnet and coil configuration, the number of repulsive magnetic motor or generator assemblies, configurations changes within the two assemblies by changing the number of the six main motor and generator rotational arms, the number of the main fixed tunable repulsive motor magnets or rings, the number of the six main rotational arm generator magnets and the twelve fixed main generator pick-up magnetic wire coils, and using different multiple section transformers in the construction and operation of the magnetic pick-up wire coils used in the generator to generate AC and DC electrical power.

### BRIEF DESCRIPTION OF THE DRAWINGS

FIG. 1: Schematic slice of two Repulsive Magnetic Motor and Generators showing two possible configurations of the Repulsive Magnetic Motor and Generator, each unit showing two of the six motor and generator rotational arms extended, the fixed rotational V magnet assemblies attached to the two extended arms, the fixed rotational magnets of the generator attached to the two extended arms, the pick-up wire coils and electrical components attached to the housing of the Repulsive Magnetic Motor and Generator, the center rotating shaft with lifting ring magnets plus stabilizing wheel bearings, the rotating arm end cap magnet assembly for stabilizing and lifting of the six main motor and generator rotational arms and all the parts found on the Itemized Parts List as viewed from a flat and straight-on component view

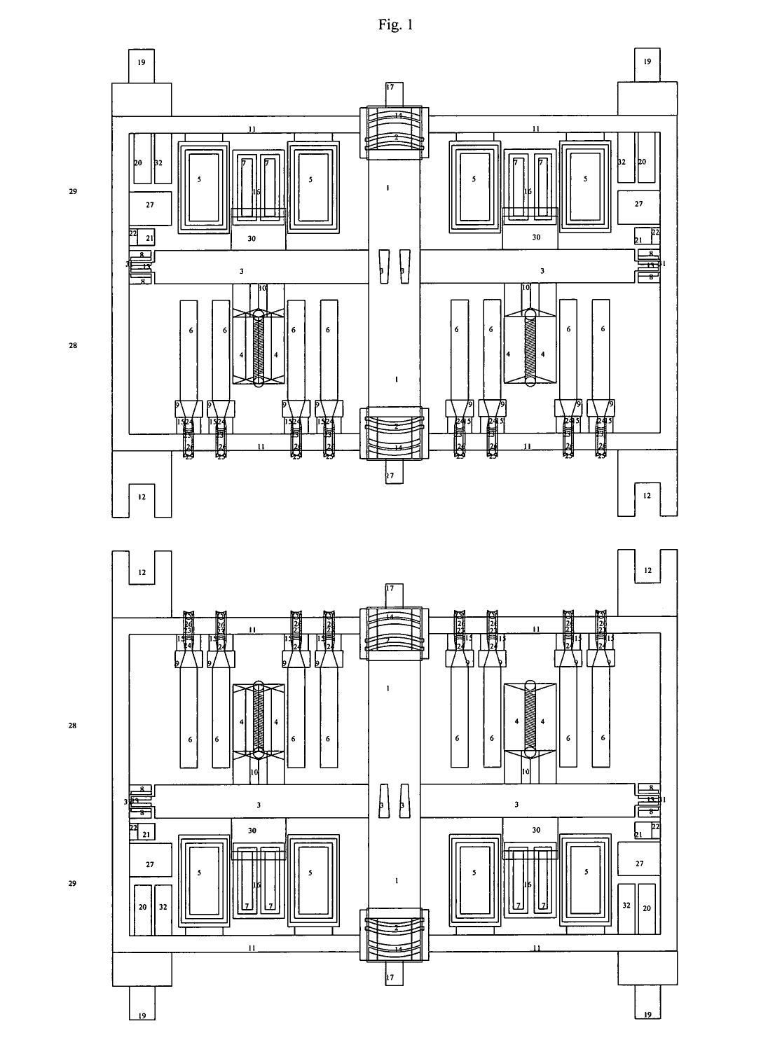

FIG. 2: Schematic slice of two Repulsive Magnetic Motor and Generators units connected to work as one unit. All items listed above in Drawing 1 apply to this drawing plus the addition of the outside case revolving center shaft sleeves required when combining two or more units that was not shown in FIG. 1

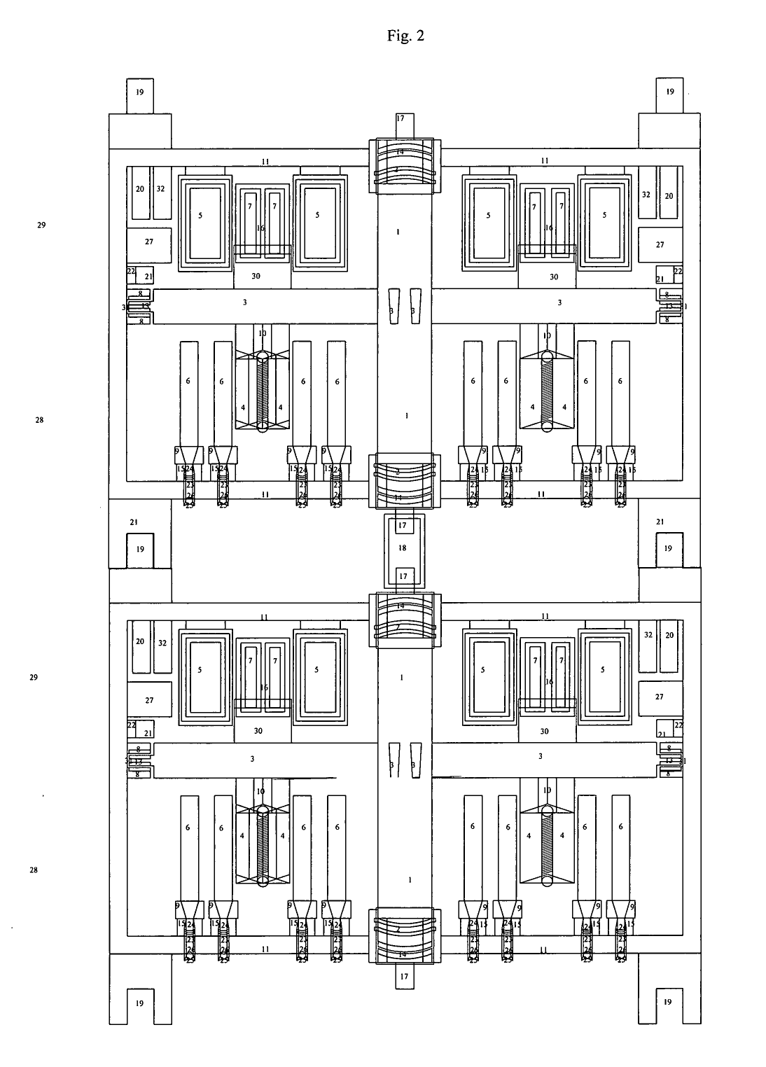

FIG. 3: Schematic view looking through the Repulsive Magnetic Motor configuration. The view shows the Repulsive Magnetic Motor's six rotational arms, the six fixed rotational arm magnet assemblies, the fixed tunable magnet assemblies attached to the frame, the six rotational arms side lifting and stabilizing ring of magnets and the center rotating shaft, the fixed top and bottom rotational arms slide track magnets, the six motor and generator rotational arm endcap magnets, ring magnets and wheel bearings layout within the Repulsive Magnetic Motor

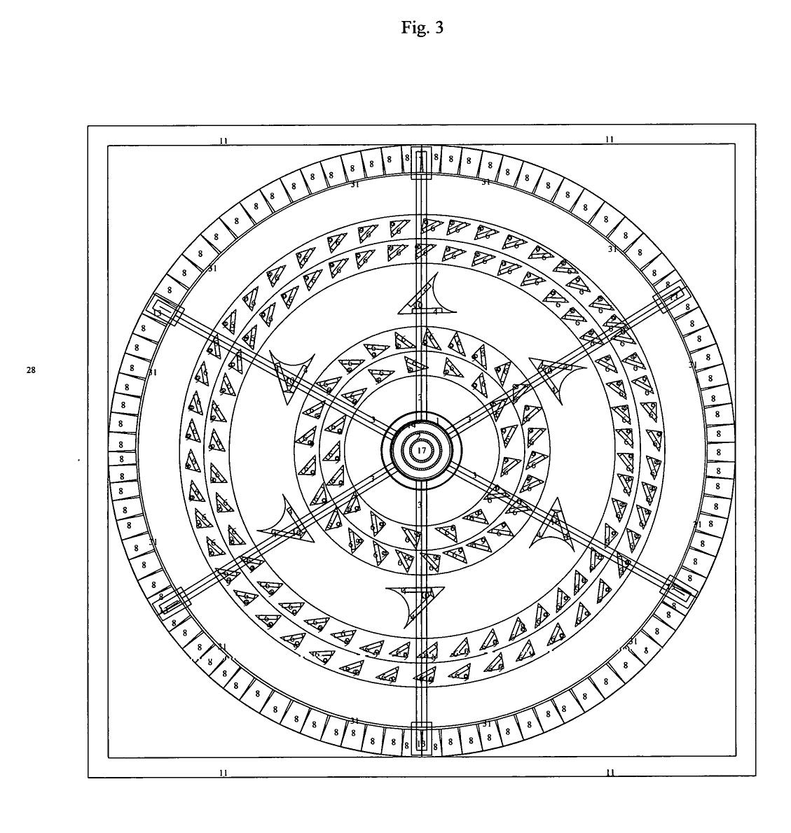

FIG. 4: Schematic view looking through the Generator's configuration. The view shows the Generator's six rotational arms, the fixed rotational magnet assemblies, the six rotational arm side lifting and stabilizing ring of magnets, the fixed twelve magnetic wire pick-up coils with the electrical components for the AC and DC electrical generation, the fixed top and bottom rotational arms slide track magnets, six motor and generator rotational arm endcap magnets and the center rotating shaft with ring magnets and wheel bearings layout within the Generator

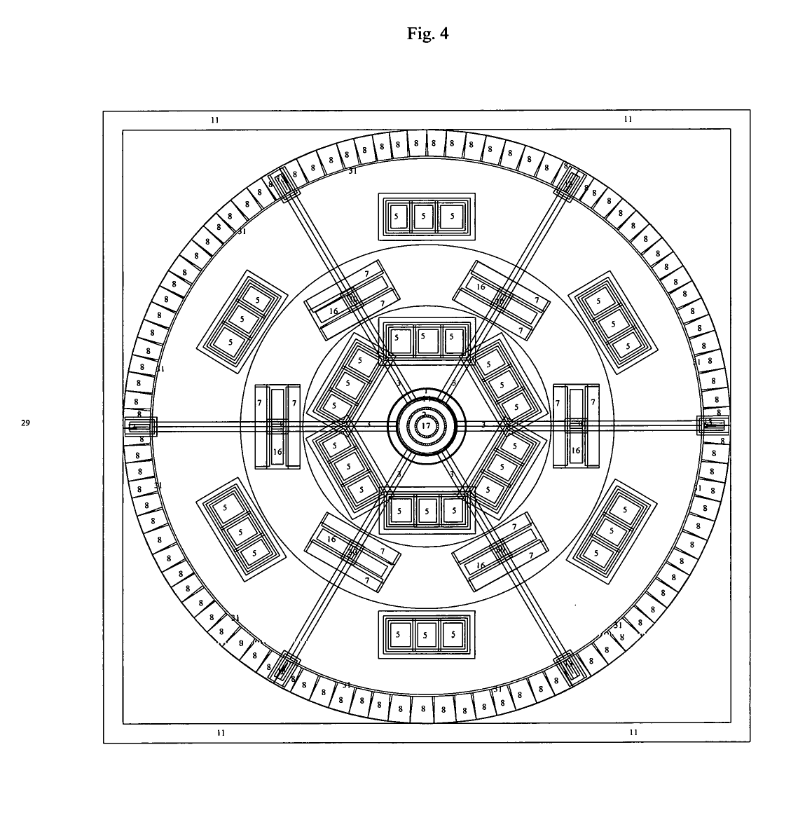

FIG. 5: Schematic view of one fixed tunable magnet assembly in the open tunable position showing the adjustable 60 tooth locking assembly and the fixed case 60 tooth locking assembly with adjustment screws used in the Repulsive Magnetic Motor for 6 degree adjustments of each of the fixed tunable magnetic assemblies

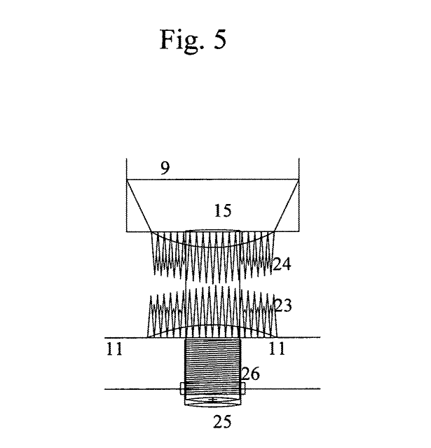

FIG. 6: Schematic drawing view of the magnetic and electro-static wave induction theory using plain naming to show the center balanced point, the extension of the 0 balanced lines in the electro-static and magnetic directions with the waves traveling along the 0 balanced lines, all forming the magnetic and electro-static fields around the 0 center balanced point

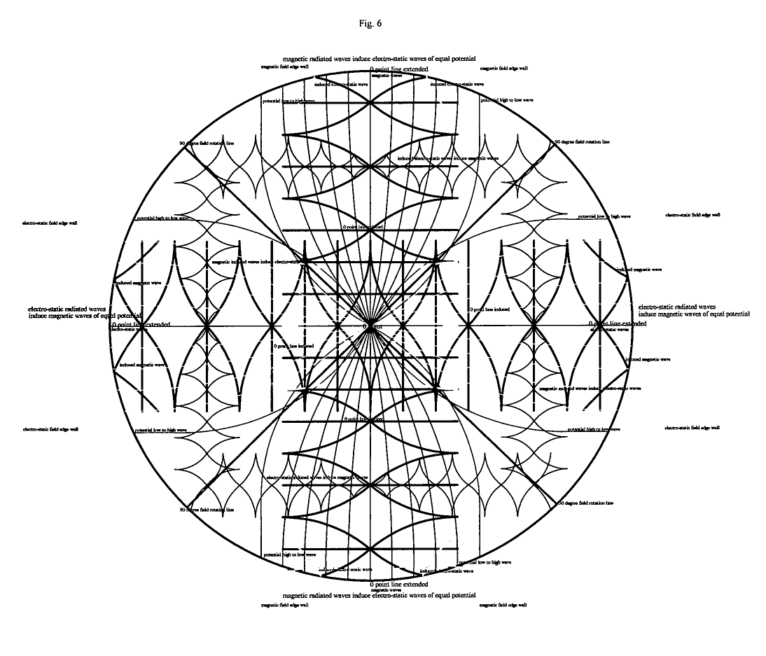

### ITEMIZED PARTS LIST

1. Motor and generator center shaft
2. Four revolving center shaft ring bearings
3. Six motor and generator rotational arms
4. Six rotational arm repulsive motor magnets
5. Twelve three-section generator pick-up magnetic wire coils
6. Fixed tunable repulsive motor magnets
7. Six rotational arm generator magnets
8. Fixed top and bottom rotational arms slide track magnets
9. Fixed tunable repulsive motor magnet assemblies
10. Six rotational arm repulsive motor magnet assemblies
11. Stackable non-magnetic housing
12. Outside case feet with stackable cavities
13. Six motor and generator rotational arm endcap magnets
14. Four revolving center shaft repulsive lift ring magnets
15. Fixed tunable repulsive motor magnet adjustment and locking assembly
16. Six rotational arm generator magnet assemblies
17. Outside case torque coupling shaft
18. Outside case revolving center shaft sleeves for combined units only
19. Outside case top stackable inserts for stacking
20. Generator charging capacitor
21. Generator circuit matching transformer
22. Full bridge diodes for the generator circuit
23. Fixed case 60 tooth locking assembly
24. Tunable 60 tooth locking assembly
25. Locking and unlocking screw and nut assembly
26. Six degree adjustment screw and shaft assembly
27. AC phase transformer for the generator's voltage output
28. Repulsive magnetic motor assembly
29. Generator assembly
30. Generator magnet cage assembly
31. Rotational arms slide track
32. DC output load capacitor

### DETAILED DESCRIPTION OF THE INVENTION

The natural design of all permeant magnets utilized four different standing wave fields, with off-sets of 90 degrees separating all four, within two of the fields the waves travel high to low and in two fields the waves travel low to high. In my design I try to take advantage of the ability to focus the repulsive electro-static and magnetic forces within natural magnets to power the Repulsive Magnetic Motor and Generator. The repulsive forces of the fixed tunable repulsive motor magnets 6 pushing against the twelve rotational arm repulsive motor magnets 4 drive the rotation of the six motor and generator rotational arms 3 connected to the motor and generator center shaft 1. The fixed top and bottom rotational arms slide track magnets 8 work with the four revolving center shaft repulsive lift ring magnets 14 allowing the six motor and generator rotational arms 3 to float within the repulsive fields. Each of the six motor and generator rotational arm's endcap magnets 13 are designed to fit inside the fixed top and bottom rotational arms slide track magnets 8 lifting and stabilizing the arms as they rotate. The repulsive electro-static and magnetic fields found in the four revolving center shaft repulsive lift ring magnets 14 are used to support the motor and generator center shaft 1 from the top and bottom reducing friction. Two sets of four revolving center shaft ring bearing 2 are used at the top and bottom of the motor and generator center shaft 1 to aid in rotational stabilization. The electro-static and magnetic fields in natural permeant bar magnets are used again as the six motor and generator rotational arms 3 move six rotational arm generator magnetic assemblies 16 through the Generator's twelve three-section generator pick-up magnetic wire coils 5 for AC power generation.

Construction of the Repulsive Magnetic Motor and Generator is made from one stackable non-magnetic stainless steel or aluminum housing 11 that is sub-divided into two internal compartments for the Repulsive Magnetic Motor Assembly 28 and the Generator Assembly 29. The Repulsive Magnetic Motor and Generator six motor and generator rotational arms 3 divide the operations of the Repulsive Magnetic Motor Assembly 28 and the Generator Assembly 29. The upper assembly is configured as a Repulsive Magnetic Motor Assembly 28 using focused repulsive electro-static and magnetic fields to generate rotational drive to the six rotational arm repulsive motor magnet 4 six rotational arm repulsive motor magnet assemblies 10 attached to the six motor and generator rotational arms 3 attached to the motor and generator center shaft 1. The lower assembly is configured as a Generator Assembly 29 using the rotational force generated by the six motor and generator rotational arms 3 to move six rotational arm generator magnet assemblies 16 through twelve three-section generator pick-up magnetic wire coils 5 to generate power. The repulsive force formed in the Repulsive Magnetic Motor rotates the six motor and generator rotational arms 3 with attached generator suspended magnet cage assemblies with six rotational arm generator magnets 7 through the twelve three-section generator pick-up magnetic wire coils 5 generating AC power in the Generator 29.

Configuration of the Repulsive Magnetic Motor Assembly 28 allows room for four rings of fixed tunable repulsive motor magnets 6 to repulse the six rotational arm repulsive motor magnet 4 held in the six repulsive motor magnet assemblies 10 attached to the six motor and generator rotational arms 3. Each of the fixed tunable repulsive motor magnets 6 fit into one of the fixed tunable repulsive motor magnet assemblies 9. The fixed tunable repulsive motor magnet assemblies 4 are adjusted using the fixed tunable repulsive motor magnet adjustment and locking assemblies 15. The adjustment of each fixed tunable repulsive motor magnets 6 is done using a fixed case 60 tooth locking assembly 23, a tunable 60 tooth locking assembly 24 with locking and unlocking screw and nut assembly 25 and using the six degree adjustment screw and shaft assembly 26 to change the focus of the fixed tunable repulsive motor magnets 6. The rotation of the six motor and generator rotational arms 3 drives the operation of the generator assembly 29. Each of the six motor and generator rotational arms 3 have one generator suspended magnet cage assembly 30 housing six rotational arm generator magnet assemblies 16 with six rotational arm generator magnets 7. As the six rotational arm generator magnets 7 rotate between the twelve three-section generator pick-up magnetic wire coils 5 they generate power. The six motor and generator rotational arms 3 used by the Repulsive Magnetic Motor 28 and in the Generator 29 are suspended by using the repulsive force between the six motor and generator rotational arm endcap magnets 13 and the fixed top and bottom rotational arm slide track magnets 8 located in the rotational arms slide track 31. The other suspended support using two of the four revolving center shaft repulsive lift ring magnets 14 placed at each end of the motor and generator center shaft 1 in a repulsive configuration supplying lift while the four center shaft ring bearings 2 aid in stabilization. The fixed top and bottom rotational arm slide track magnets 8 are configured allowing the six motor and generator rotational arm endcap magnets 13 to fit between the fixed top and bottom rotational arm slide track magnets 8 in the rotational arms slide track 31 giving balance, stability and lift to the six motor and generator rotational arms 3.

The six motor and generator rotational arms 3 support the six generator magnet cage assemblies 30 housing the six rotational arm generator magnets 7 needed to produce AC power. The six main rotational arm generator magnets 7 rotate between the twelve three-section generator pick-up magnetic wire coils 5 in the generator assembly 29. As the six motor and generator rotational arms 3 rotate the six main rotational generator magnets 7 between the twelve three-section generator pick-up magnetic wire coils 5 in the generator assembly 29, the circuits of the twelve three-section generator pick-up magnetic wire coils 5 generate AC voltage. The magnetic potential developed in the twelve three-section generator pick-up magnetic wire coils 5 are directed to the generator circuit matching transformers 21 being developed across the main generator charging capacitors 20 and being outputted as AC through AC transformer 27. The DC voltage output is developed using the circuit components of the full bridge diodes 22 and the DC output load capacitors 32.

Each Repulsive Magnetic Motor and Generator is designed to be stackable using four outside case feet with stackable cavities 12, and a second Repulsive Magnetic Motor and Generator with outside case top stackable inserts 19 connected together. Each of the two Repulsive Magnetic Motor and Generators as stacked have the outside case torque coupling shaft 17 connecting the outside case revolving center shaft sleeves 18 together allowing synchronous operation of both Repulsive Magnetic Motor and Generator units.

### Theory and Construction of the Invention

This patent and my theory on magnetic and electro-static waves developed together and greatly aided in the design and development of this invention, the Repulsive Magnetic Motor and Generator. My first questions on what is energy and fields, how do they develop and transfer and what is magnetics and how does It work led to increased research into each subject only to find a lack of understanding on how things really work. The best question on why is the ninety degree separation between magnetic and electro-static waves important became the key to everything. The understanding of the answers to these and other questions is the basis theory for the development of the Repulsive Magnetic Motor and Generator patent.

At the point where I first envisioned the magnetic standing waves of a bar magnetic and how the fields act to support each other, changed my understanding as to how magnetic and electro-static field act. This lead to expanding the theory until it including the forming of the Universe from magnetic and electro-static waves radiating from a balanced point in the center of the Universe and reflecting from the fields created at the edge of the Universe. Magnetic and electro-static waves travel high to low and low to high crossing zero only one time allowing two complete waves to exist within one cycle. The first generated waves in our Universe traveled throughout space in all four directions on two ninety degree planes from a central point. The traveling of the waves from the central point to the fields at the edge of the Universe created no interaction in any of the waves. Upon hitting the field edge on our Universe the waves in all planes reflected into the out-going waves following them. This interaction created the first balanced and unbalanced energy particles. Magnetic waves generate electro-static waves at right angles as they move and electro-static waves generate magnetic waves at right angles as they move due to the projection of the zero point lines through space, meaning reflected wave interactions took place on two planes at the same time. This is important because from the two planes interaction came the generation of balanced and unbalanced particles with different spin speeds and different directional rotations that caused the warping of space. Space having weight and being completely passive and balanced in all other respects carried all the radiating waves to the circular edge of the Universe and reflect each of the waves back at slightly different angles into the outgoing waves causing interaction between the waves.

The interactions of the waves are related to the balance of the resultant particle's spin balance after the wave centers combine. Waves combining at exactly ninety degrees form energy particles rotating in a perfect spin and require no further interaction. But waves forming particles with other than ninety degrees due allow further interaction of the particles. As waves combine forming balanced energy particles, the balanced center of the new particle increases in power because the center becomes a more-prefect-balance and reduces in size. As the center reduces in size the outside energy particle's shell is moved farther from the center and increases in potential. (Note: the potential of a wave is affected by its distance from the zero line radiating from the center balance point through each of the radiated waves). The result of all of the waves combining through-out the Universe is the forming of the first balanced and unbalanced energy particles with spin, weight, momentum, direction and potential. The balanced and unbalanced energy partials formed were larger than space in size and were the first partials to cause the displacement of space causing each partial to have weight. The wrapping of the combining waves generate a high rate of spin with the directional velocity of the waves that combined causing different spinning directions in the energy partials relative to each other resulting in the positive and negative potentials found in the matter. The relative speed of spin of the atoms after different balanced and unbalanced energy particles combined allows the atoms to have different properties and to react to different frequencies as stimulus.

Matter and dark matter were formed from slowed energy partials combined spin and space displacement. Matter being made from balanced and unbalanced energy combining to form new particles with relatively slower energy spins allows the frequency spectrum interaction of the earth's magnetic and electro-static field, the sun's frequency spectrum interaction, the center of the galaxy's magnetic and electro-static field and the matter and dark matter interaction in the Universe. Energy is not transferred but stimulation is. This allows the laws of nature to function as stable and reoccurring actions. Matter can be affected by the use of a stimulus containing different frequencies acting upon the matter at different angles to increase the level of some of the embedded energy within the matter. Whatever frequency is used to elevate the energy in matter, the same frequency will be given off as the matter returns to the steady state. The orientation of the frequency stimulus will resonate some of the cavities within the centers of matter resulting in the amount of energy increase the over-all matter will experience. The magnetic and electro-static waves from the black hole at the galaxy's center coupled with the earth's magnetic and electro-static wave radiation and the frequency spectrum transmitted from the matter in the sun all generate a band of frequencies through space impacting matter on the earth. The earth receives the generated frequencies and begins to resonate. Depending on the orientation of the transmitted frequencies the resonate centers within the balanced and unbalanced energy centers of the receiving matter allows different centers to respond to different frequencies.

Permanent magnetic material was made from a larger percentage of balanced energy partials than any other matter. Balanced energy partials formed from waves intersecting at exactly ninety degrees. The ninety degree separation is the key to energy being able to receive and radiate magnetic and electro-static fields as standing waves from their balanced center. This allows for strong magnetic and electro-static waves to radiate from the balanced cavity centers of permanent magnets after they are formed. The intersection and interaction of the standing waves of a permanent magnet with the energy already found in the matter in the magnetic pick-up wire coupled with the two distinct waves occurring each cycle allows the electro-static and magnetic waves to induce a potential in the wire allowing modern electronics and electrical circuits to function, as long as the wire configuration completes a circuit loop through ground or to itself maintaining the circuit balance. In general magnetic fields align and carry while electro-static fields are the potentials.

The Repulsive Magnetic Motor and Generator case will be constructed of steel to allow shielding of the fields inside and grounding. The internal rotating parts will be constructed from non-magnetic stainless steel or aluminum. In the test device aluminum or wood will be used due to their light weight and ease of construction molding. All of the electrical components used in the construction of the Generator will be common devices except for some of the special electrical transformers. Due to the shape and limited space some electrical transformers will be hand wound using larger gage copper wire. All of the natural magnets and bearings used in the construction of the Repulsive Magnetic Motor and Generator will be common devices.

### Statements of Energy

Theory Statement: The collision of the rebounding magnetic and electro-static waves from the universe's shell wall into the outgoing magnetic and electro-static waves from its center caused the collapse of the colliding waves to form perfectly separated ninety degree waves forming a perfectly balanced spinning particle of energy. This perfectly balanced spinning particle of energy was the fastest rotating particle in the universe and warped space because of their interaction. The perfectly spinning particle in being a stable high potential energy particle required no other combination interactions. Waves combining at less than a perfect ninety degree coupling combined to form other new energy particles but did not have a perfectly balanced spin causing oscillation and a less perfectly balanced center, creating a larger center and a lower potential. The more the two coupling waves were offset from each other, the greater the unbalance in the magnetic and the electro-static wave coupling, the larger the combined particles center becomes because the resultant spin is less balanced causing a lower potential energy particle. Both energy particles cause a warping of space due to their spin and size. The perfectly balanced spinning particles with their reduced center size and greater potential spin fit between the imperfectly spinning particles when both are joined to form larger new partials. A pulsation of the warped space between all the balanced and unbalanced particles draws both types of energy particles together in different configurations. As different combinations begin to revolve around each other they slow down the combined revolution spin of the newly combined group due to restrains caused by each energy particle's warping of space and the interaction caused by the relative directional spin of the energy particles combining. Matter forms as the spin of combined energy particles slow down the revolution of the new group to the point where the size of the center has grown to an atom. The electrons we see are the imperfect energy partials revolving shells. Thus all matter is made of energy and all energy is made from rippling waves of collapsed space.

Statement 1: Energy cannot be created or destroyed and cannot exist as a single energy particle without recombining with other energy particle in matter. All matter is made from energy showing a relatively slower spin after balanced and unbalanced spinning particle combinations formed atoms.

Statement 2: Energy in matter is stimulated by the frequency spectrum generated by the sun and other close stars, the frequency spectrum generated by the magnetic and electro-static standing waves transmitted from the magnetic center of the black hole in the center of all galaxies and from other collapsed stars and the frequency spectrum generated by the magnetic and electro-static fields generated from the earth and other planets possessing magnetic fields.

Statement 3: Perfectly spinning energy particles formed from two or more waves colliding at exactly ninety degrees. The collapsed waves formed the fastest spinning particles in the early universe. Perfectly spinning particles, depending on their orientation to the generated waves, receives stimulation from magnetic and electro-static waves causing an increase in their speed-of-spin. The increase in rotational speed reduces the size of the center of each particle creating a more perfect balance in the particle. The reducing of the center expands the particle's shell potential due to the increasing distance between the shell wall (formed by the maximum outer wave's potential) and the reduced center. This action causes an increase in the warping of space around the increased spinning particle as the particle's outer wall increases in size. The same is true when the energy particle returns to normal; it generates the frequency it received during stimulation reducing the centers speed-of-spin and increasing the instability of the rotation. This causes the center to increase in size reducing the distance between it and the shell wall reducing the energy potential of the particle.

Statement 4: Imperfect spinning energy particles formed from waves colliding at less or more than ninety degrees creating a less stable center, slower spin speeds and a larger particle as the waves collapsed inward. As imperfect spinning energy partials spin slower with an imperfect outer wall, the space warping around them is distorted. They receive a frequency band of stimulation from the sun in the form of their generated frequency spectrum. Different unbalanced partials having differently sized centers and shell wall potentials will respond to different frequency stimulation depending on their orientation to the generated waves. All unbalanced partials have the same reaction when receiving stimulation; the spin increases and the center reduce in size as the shell wall potential expands. But the balance of the unbalanced particle worsens with increased rotational speed and the vibration of the particle increases. Depending on the amount of the particle's vibration before stimulation dictates the particles reaction as stimulation is increases. When the unbalanced spinning partials return to normal they generate the band of frequencies they absorbed becoming more balanced and increasing the center's size reducing the shell wall's potential.

What is claimed:

1. Six motor and generator rotational arms in an evenly spaced configuration attached around the motor and generator revolving center shaft, allowing each arm to support one rotational repulsive magnetic motor assembly attached above in a v design that can be repelled by four rings of fixed tunable repulsive motor magnet assemblies suspended from the upper case: When the four fixed rings of the fixed tunable repulsive motor magnet assemblies focus through tuning the repulsive magnetic and electro-static forces on the six rotational arm repulsive motor magnet assemblies, a repulsive force great enough to generate rotational torque can be generated and sustained by the six motor and generator rotational arms

2. Four revolving center shaft repulsive lift ring magnets arranged in a repulsive magnetic and electro-static field configuration when used in combination with the two revolving center shaft ring bearings and the fixed top and bottom rotational arms slide track magnets will supporting and stabilize the rotation of the six rotational arms used by the Repulsive Magnetic Motor and Generator assembly

3. Six rotational arm generator magnet assemblies revolving between the twelve/three-section fixed main generator pickup magnetic wire coils will generate an AC voltage that can be configured through electronic and electrical circuits to generate AC and DC power.

4. Arm and leg peg and insert posts coupled with the ability to couple the motor and generator revolving center shaft of different Repulsive Magnetic Motor and Generator units will allow for stacking and phasing of multiple units and would allow the support of a wider range of AC and DC power applications and solutions.

5. One common motor and generator revolving center shaft structure configured with six motor and generator rotational arms, each arm used to support and balance the repulsive magnetic motor assemblies and the generator magnet cage assemblies greatly reduce the size, weight and number of parts needed for the invention.
